(19) United States
(12) Patent Application Publication
(10) Pub. No.: US 2002/0184576 A1
(43) Pub. Date: Dec. 5, 2002

(54) Method and apparatus for isolating failing hardware in a PCI recoverable error

(75) Inventors: Richard Louis Arndt, Austin, TX (US); Daniel James Henderson, Pflugerville, TX (US); Robert George Kovacs, Austin, TX (US); John Thomas O'Quin II, Austin, TX (US); David R. Willoughby, Austin, TX (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY (US)

(21) Appl. No.: 09/820,459

(22) Filed: Mar. 29, 2001

(51) Int. Cl. G06F 11/00

(52) U.S. Cl. 714/48

(57) ABSTRACT

A method, apparatus, and computer implemented instructions for isolating failing hardware in a data processing system. In response to detecting a recovery attempt from an error, an indication of the attempt is stored. A hardware component associated with the error is placed in an unavailable state in response to the error exceeding a threshold for errors.

### BACKGROUND OF THE INVENTION

1. Technical Field

The present invention relates generally to an improved data processing system, and in particular to a method and apparatus for processing errors in a data processing system. Still more particularly, the present invention provides a method, apparatus, and computer implemented instructions for isolating failing hardware in response to errors in the data processing system.

2. Description of Related Art

By definition, a logically partitioned (LPARed) system is one in which multiple operating systems (OSs) or multiple instances (multiple copies of the OS loaded into memory) of the same OS can be running on the system simultaneously. It is a requirement that all errors, both hardware and software, be isolated to the partition or partitions that are affected by the particular error.

For input/output (I/O) subsystems, this requirement can be tricky, since I/O bus architectures are not designed to isolate their errors between I/O adapters such that one I/O adapter does not “see” errors occurring on a different I/O adapter. Thus, an error occurring in a single I/O adapter may cause an error that cannot be isolated, with existing architectures, to one single partition. In some cases, errors occurring in the system are recoverable. In currently available systems, a repair action may be indicated, but the systems are unable to isolate the faulty hardware component.

Therefore, it would be advantageous to have an improved method and apparatus for isolating failing hardware in response to recoverable errors.

### SUMMARY OF THE INVENTION

The present invention provides a method, apparatus, and computer implemented instructions for isolating failing hardware in a data processing system. In response to detecting a recovery attempt from an error, an indication of the attempt is stored. A hardware component associated with the error is placed in an unavailable state in response to the error exceeding a threshold for errors.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a block diagram of a data processing system, which may be implemented as a logically partitioned server in accordance with the present invention;

FIG. 2 is a block diagram of a terminal bridge in accordance with the present invention;

FIG. 3 is a diagram illustrating components used in isolating failing hardware in recoverable errors in accordance with a preferred embodiment of the present invention;

FIG. 4 is a flowchart of a process used for handling errors in accordance with a preferred embodiment of the present invention;

FIG. 5 is a flowchart of a process used for placing a device into an unavailable state in accordance with a preferred embodiment of the present invention; and

FIG. 6 is a flowchart of process used for resetting a slot in accordance with a preferred embodiment of the present invention.

### DETAILED DESCRIPTION OF THE PREFERRED EMBODIMENT

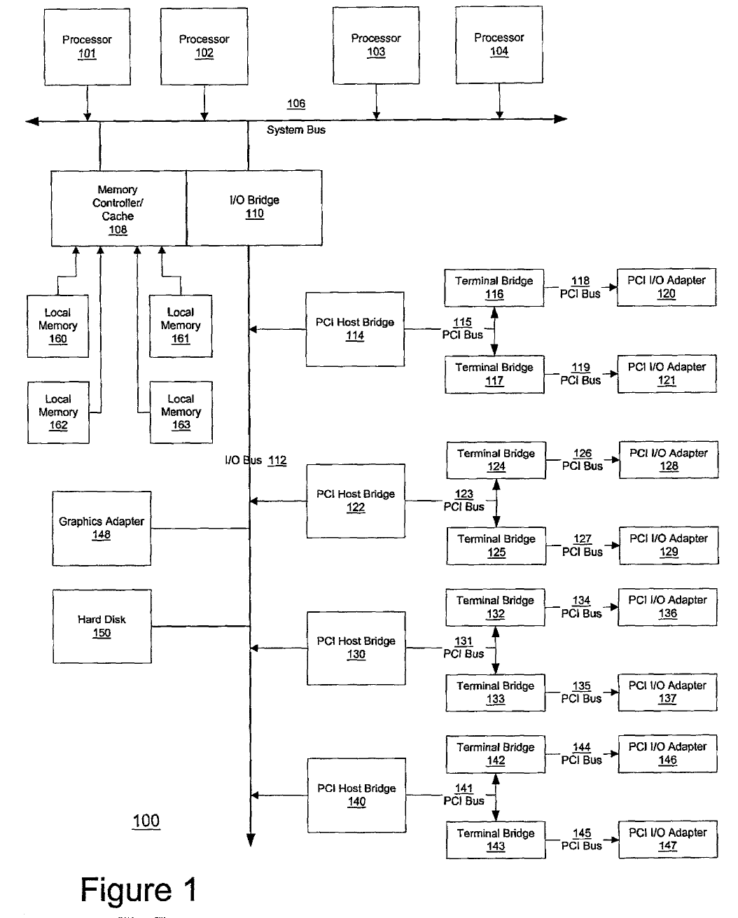

With reference now to FIG. 1, a block diagram of a data processing system, which may be implemented as a logically partitioned server is depicted in accordance with the present invention. Data processing system 100 may be a symmetric multiprocessor (SMP) system with a plurality of processors 101, 102, 103, and 104 connected to system bus 106. For example, data processing system 100 may be an IBM RS/6000, a product of International Business Machines Corporation in Armonk, N.Y. Alternatively, a single processor system may be employed. Also connected to system bus 106 is memory controller/cache 108, which provides an interface to a plurality of local memories 160-163. I/O bus bridge 110 is connected to system bus 106 and provides an interface to I/O bus 112. Memory controller/cache 108 and I/O bus bridge 110 may be integrated as depicted.

Data processing system 100 is a logically partitioned data processing system. Thus, data processing system 100 may have multiple heterogeneous operating systems (or multiple instances of a single operating system) running simultaneously. Each of these multiple operating systems may have any number of software programs executing within in it. Data processing system 100 is logically partitioned such that different I/O adapters 120-121, 128-129, 136-137, and 146-147 may be assigned to different logical partitions.

Thus, for example, suppose data processing system 100 is divided into three logical partitions, P1, P2, and P3. Each of I/O adapters 120-121, 128-129, 136-137, and 146-147, each of processors 101-104, and each of local memories 160-164 are assigned to one of the three partitions. For example, processor 101, local memory 160, and I/O adapters 120, 128, and 129 may be assigned to logical partition PI; processors 102-103, memory 161, and I/O adapters 121 and 137 may be assigned to partition P2; and processor 104, memories 162-163, and I/O adapters 136 and 146-147 may be assigned to logical partition P3.

Each operating system executing within data processing system 100 is assigned to a different logical partition. Thus, each operating system executing within data processing system 100 may access only those I/O units that are within its logical partition. For example, one instance of the Advanced Interactive Executive (AIX) operating system may be executing within partition P1, a second instance (image) of the AIX operating system may be executing within partition P2, and a Windows 2000™ operating system may be operating within logical partition P1. Windows 2000 is a product and trademark of Microsoft Corporation of Redmond, Wash.

Peripheral component interconnect (PCI) host bridge 114 connected to I/O bus 112 provides an interface to PCI local bus 115. A number of Terminal Bridges 116-117 may be connected to PCI bus 115. Typical PCI bus implementations will support four terminal bridges for providing expansion slots or add-in connectors. Each of terminal bridges 116-117 is connected to a PCI I/O adapter 120-121 through a PCI Bus 118-119. Each I/O adapter 120-121 provides an interface between data processing system 100 and input/output devices such as, for example, other network computers, which are clients to server 100. Only a single I/O adapter 120-121 may be connected to each terminal bridge 116-117. Each of terminal bridges 116-117 is configured to prevent the propagation of errors up into the PCI host bridge 114 and into higher levels of data processing system 100. By doing so, an error received by any of terminal bridges 116-117 is isolated from the shared buses 115 and 112 of the other I/O adapters 121, 128-129, and 136-137 that may be in different partitions. Therefore, an error occurring within an I/O device in one partition is not “seen” by the operating system of another partition.

Thus, the integrity of the operating system in one partition is not affected by an error occurring in another logical partition. Without such isolation of errors, an error occurring within an I/O device of one partition may cause the operating systems or application programs of another partition to cease to operate or to cease to operate correctly.

Additional PCI host bridges 122, 130, and 140 provide interfaces for additional PCI buses 123, 131, and 141. Each of additional PCI buses 123, 131, and 141 are connected to a plurality of terminal bridges 124-125, 132-133, and 142-143, which are each connected to a PCI I/O adapter 128-129, 136-137, and 146-147 by a PCI bus 126-127, 134-135, and 144-145. Thus, additional I/O devices, such as, for example, modems or network adapters may be supported through each of PCI I/O adapters 128-129, 136-137, and 146-147. In this manner, server 100 allows connections to multiple network computers. A memory mapped graphics adapter 148 and hard disk 150 may also be connected to I/O bus 112 as depicted, either directly or indirectly.

The mechanism of the present invention may be implemented within data processing system 100 to isolate failing hardware in response to recoverable errors. The hardware is isolated when the recoverable error occurs more often than a selected threshold. In these examples, the threshold is exceeded when a third attempt occurs to retry the same operation in which a recoverable error occurs. In response to the threshold being exceeded, the hardware component is placed in an unavailable state. In this manner, calls to the hardware component will result in a response that the hardware component is unavailable.

Those of ordinary skill in the art will appreciate that the hardware depicted in FIG. 1 may vary. For example, other peripheral devices, such as optical disk drives and the like, also may be used in addition to or in place of the hardware depicted. The depicted example is not meant to imply architectural limitations with respect to the present invention.

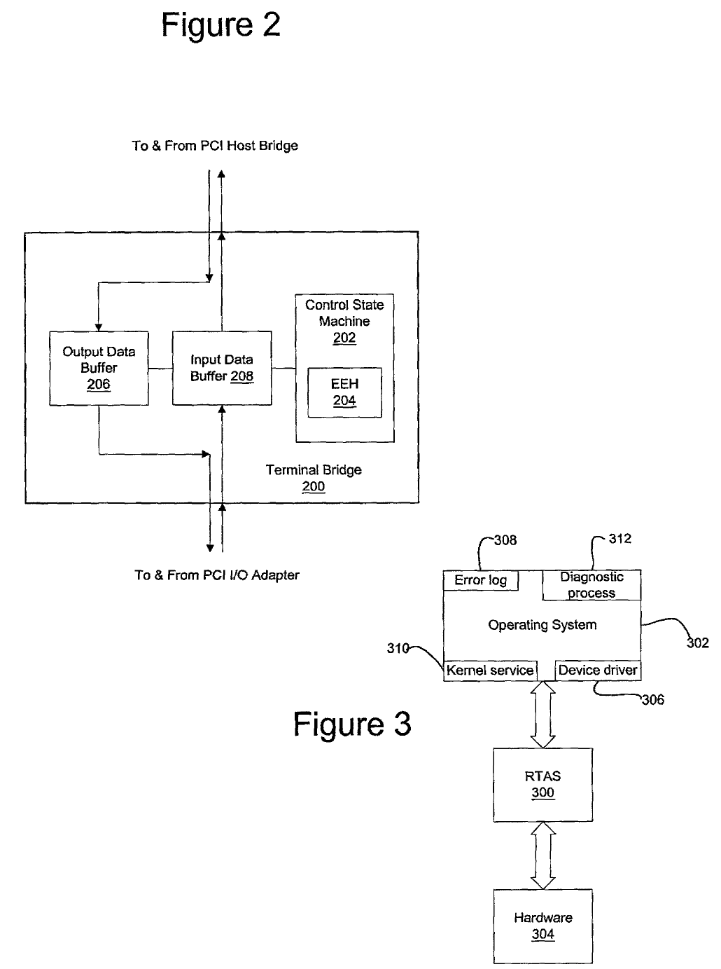

With reference now to FIG. 2, a block diagram of a terminal bridge, which may be implemented as one of terminal bridges 116-117, 124-125, 132-133, and 142-143 in FIG. 1, is depicted in accordance with the present invention. Terminal bridge 200 includes control state machine 202, output data buffer 206, and input data buffer 208. Control state machine 202 includes enhanced error handling (EEH) unit 204.

EEH unit 204 within terminal bridge 200 provides a mechanism for detecting PCI bus errors for operations, such as, for example, Load or Store operations. Further, EEH unit 204 also provides a mechanism for retrying operations in response to detecting the errors. These functions are also referred to as bus error recovery.

Output data buffer 206 is a small memory bank that receives data from a PCI Host Bridge, such as, for example, PCI host bridge 114 in FIG. 1, and stores the data for processing by control state machine 202 prior to passing it on to a PCI I/O adapter, such as for example, PCI I/O adapter 120. Input data buffer 208 is also a small memory bank that receives data from the PCI I/O adapter and stores the data for processing by control state machine 202 prior to passing it on to the PCI host bridge. The control state machine directs the flow of operations between the PCI Host Bridge PCI bus and the PCI I/O Adapter PCI bus. This control is generally described by the PCI-to-PCI Bridge Architecture Specification, as defined by the PCI Special Interest Group.

EEH 204 within control state machine 202 is added by the present invention and prevents errors from the I/O adapter from being propagated up into the shared buses of the other I/O adapters, such that these errors are isolated from other logical partitions.

In order for errors to be isolated from the shared buses of other I/O adapters that may be in different partitions from the I/O adapter on which the error occurred, the following conditions should be met. When the I/O adapter attached to the terminal bridge encounters an error on its PCI bus, it is placed into the enhanced error handling (EEH) stopped state. The EEH stopped state is the state where no further operations are allowed to cross the bridge either to or from the I/O adapter (i.e., Load and Store operations to the I/O adapter are blocked and DMA operations from the I/O adapter are blocked). In the EEH stopped state, control state machine 202 prevents these operations.

When entering the EEH stopped state, any data in buffers 206-208 for that I/O adapter is discarded. From the time that the I/O adapter EEH stopped state is entered, the I/O adapter is prevented from responding to load and store operations from processors 102 and 104 in FIG. 1. A load operation returns all 1's in the data to the processor software which is executing the load operation, with no error indication, and a store operation is ignored (i.e., the load and store operations are treated as if they received a master-abort error, as defined by the PCI local bus specification), until the software explicitly releases terminal bridge 200 so that the device driver can continue load/store operations to the I/O adapter.

Also, from the time that the I/O adapter EEH stopped state is entered, the I/O adapter is prevented from completing a DMA operation, until the software explicitly releases terminal bridge 200 so that the I/O adapter can continue DMA operations. For example, when the I/O adapter requests access to the bus by activating the PCI REQ signal on the bus, do not signal the I/O adapter that the operation may proceed by activating the PCI GNT signal on the bus or, alternatively, activate the PCI GNT signal, but then signal a target-abort of the operation, as defined by the PCI local bus specification (i.e., target creates a certain signal combinations on the bus, as defined by the PCI Local Bus Specification, which signals that the target is aborting the operation).

When the I/O adapter is the master of the operation (i.e., when the I/O adapter is the initiator of the operation), as defined by the PCI Local Bus Specification, terminal bridge 200 for that I/O adapter does not place the I/O adapter into the EEH stopped state on any of the errors listed in Table 1 and discards any write data if the operation is a write operation.

TABLE 1

| | |
|---|---|
| (1) | I/O adapter Master-Aborts |
| (2) | I/O adapter write operation with bad data |
| | parity |
| (3) | I/O adapter Target-Aborted by the terminal |
| | bridge |
| (4) | I/O adapter detects bad data parity on a read |
| | operation from the terminal bridge |

An I/O adapter master-abort error occurs when the terminal bridge detects bad address parity and does not respond. Therefore, the I/O adapter master-aborts the operation. When an I/O adapter write operation with bad data parity error occurs, the terminal bridge activates the PCI bus parity error (PERR) signal to the I/O adapter and discards the write operation. When an I/O adapter detects bad data parity on a read operation from the terminal bridge, the I/O adapter activates the PCI bus PERR signal to the terminal bridge.

If the I/O adapter is master and the EEH function is enabled for that I/O adapter, then the terminal bridge places the I/O adapter into the EEH stopped state on occurrence of any of the conditions listed in Table 2 and discards any write data if the operation is a write operation.

TABLE 2

| | |
|---|---|
| (1) | the I/O adapter activates the PCI bus SERR |
| | signal |
| (2) | the I/O adapter's posted write fails |

A posted write means that the I/O adapter is no longer on the bus. An I/O adapter's posted write to the terminal bridge may fail to the PCI host bridge (PHB) for transfers to the system. For peer-to-peer operations, the posted write may fail to another terminal PCI bus. The posted write may fail if the target, which is the PHB or another I/O adapter beneath the same terminal bridge, does not respond. Also in peer-to-peer operations, the posted write may fail if the target signals a target-abort, or if the target detects a data parity error and signals a PERR. If an I/O adapter posted write to the terminal bridge fails and the terminal bridge cannot determine the originating I/O adapter master, then the terminal bridge either places all the terminal bridges for all the I/O adapters that might have been the originating I/O adapter master, into the EEH stopped state, or the terminal bridge drives a non-recoverable error (for a PCI bus, that would be a SERR) to the PHB.

When the PHB is master for a load or store operation, the terminal bridge does not place the target I/O adapter into the EEH stopped state on any of the conditions listed in Table 3 occurs and discards any write data in the buffers 206-208 if the operation is a write operation.

TABLE 3

| | |
|---|---|
| (1) | the PHB Master-Aborts |
| (2) | the PHB attempts a read/write operation with |
| | bad address parity |
| (3) | the PHB is Target-Aborted by the terminal |
| | bridge |
| (4) | the PHB detects bad data parity on a read |
| | operation from the terminal bridge |

In the case where the PHB attempts a read/write (i.e., load/store) operation with bad address parity, the terminal bridge does not respond, so the PHB master-aborts.

If the PHB is the master (i.e., for a load or store operation) and the terminal bridge for the target I/O adapter has the EEH function enabled, then the terminal bridge for the target I/O adapter places the I/O adapter into the EEH stopped state and discards any write data if the operation is a write operation or returns all l's in the data, on any of the occurrence of any of the conditions listed in Table 4.

TABLE 4

| | |
|---|---|
| (1) | the PHB delayed read fails on the terminal PCI |
| | bus, |
| (2) | the PHB delayed write (i.e., Store to PCI I/O |
| | space) fails on the target PCI bus and the terminal |
| | bridge returns no error to the PHB, |
| (3) | the PHB posted write operation (Store to PCI |
| | memory space) to the terminal bridge fails on the |
| | terminal PCI bus |
| (4) | the PHB write (Store) data has bad parity and |
| | the terminal bridge drives PERR to the PHB and |
| | discards the write data. |

The PHB posted write operation to the terminal bridge fails on the terminal PCI bus occurs when the I/O adapter does not respond, and therefore, the terminal bridge master-aborts, or the I/O adapter signals a target-abort or PERR.

If the terminal bridge for the I/O adapter sees a SERR signaled, the terminal bridge places the I/O adapters on that terminal bus into the EEH stopped state. Finally, the I/O adapter does not share an interrupt with another I/O adapter in the platform.

Store operations from the software are many times used to setup I/O operations in an I/O adapter. The EEH stopped state prevents any corruption of data in the system by preventing the software from starting a particular I/O operation when a previous Store to the I/O adapter fails. For example, the software issues Store operations to the I/O adapter to tell the I/O adapter what address and what data length to transfer and then tells the I/O adapter via a different Store to initiate the operation. If one of the Stores prior to this initiation Store has failed, then the I/O adapter may transfer the data to or from the wrong address or using the wrong length, and the data in the system will be corrupted. By putting the I/O adapter into the EEH state, the Store operation, which is used to initiate the I/O operation in the I/O adapter will never reach the I/O adapter, thus preventing transfer to or from the wrong address or with an invalid length.

In another methodology, I/O operations are sometimes initiated through memory queues in local memory 160 in FIG. 1. The software sets up an operation in a queue in local memory 160 and then tells the I/O adapter to begin the operation. The I/O adapter then reads the operation from local memory and updates the queue information in local memory by writing data to the local memory queue structure, including a status of the operation that it has performed (e.g., operation complete without error or operation completed with error). By placing the I/O adapter into the EEH stopped state and preventing further operations by the I/O adapter after an error from which the I/O adapter cannot recover (e.g., a failure of a posted write operation to local memory), the I/O adapter is prevented from signaling good completion of the operation in the local memory queue when in reality the data sent to local memory during the operation was in error.

While an I/O adapter is in the EEH stopped state, a load operation issued from the software to the I/O adapter will return a data value of all-1's in the data bits. If the software looks at the returned data and determines that it is all-1's when it should not be (e.g., status bits in a status register that the software is expecting to be a value of 0) then it can determine that the terminal bridge may be in the EEH stopped state and can then look at the terminal bridge status registers to see if it is indeed in the EEH stopped state. If the terminal bridge is in the EEH stopped state, then the software can initiate the appropriate recovery procedures to reset the adapter, remove the terminal bridge from the EEH stopped state, and restart the operation. More information on EEH errors may be found in Isolation of I/O Bus Errors to a Single Partition in an EPAR Environment, application Ser. No. 09/589,664, filed Jun. 8, 2000, which is incorporated herein by reference.

Turning next to FIG. 3, a diagram illustrating components used in isolating failing hardware in recoverable errors is depicted in accordance with a preferred embodiment of the present invention. In these examples, runtime abstraction services (RTAS) 300 provide an interface between operation system 302 and hardware system 304. In particular, RTAS 300 translates calls made by components within operating system 302, such as device driver 306 into appropriate calls or commands to hardware 304. Device driver 306 is a component within operating system 302 used to interface with devices within hardware 304. Hardware 304 includes various devices, such as I/O adapter 120 in FIG. 1. RTAS 300 deals directly with the hardware and avoids requiring device driver 306 having to be configured to make these calls. In other words, RTAS 300 is similar to application programming interfaces (APIs) within operating system 302 from which programs may make calls using these APIs.

For recoverable master or target abort errors, device driver 306 of operating system 302 receives an interrupt indicating the abort and device driver 306 can retry the operation. When an EEH recoverable error is detected by device driver 306, device driver 306 may send the calls to RTAS 300 to reset the hardware component, which is an I/O device in this example, and allow the operation to be retried. Then, device driver 306 may retry the operation. In either recovery case, when such a recovery is attempted, device driver 306 logs an error report into error log 308 within operating system 302 indicating that a recoverable error has been detected. In the depicted examples, an error report will include information indicating the device that the device driver was accessing, but not indicate that any service action is required. Additionally, device driver 306 will make a call to RTAS 300 to reset the slot in the EEH case. In these examples, this reset call is made through kernel service 310 for the PCI bus. Although device driver 306 could be designed to make calls directly to RTAS 300, kernel service 310 is a component within operating system 302 providing functions for device driver 306 in which kernel service 310 makes calls directly to RTAS 300 for device driver 306 and other components within operating system 302.

After a third successive attempt to retry the attempted operation, device driver 306 sends a call to RTAS 300 to indicate that the I/O device should be placed into a permanent reset or unavailable state. The call is placed through kernel service 310, which in turn sends the call to RTAS 300. This call is made because of the number of recoverable errors occurring. Although in this example, the threshold for such an action is three successive errors for the same operation, other threshold levels may be used. For example, the threshold may be five successive errors for the same operation, seven successive errors for different operations, or four errors for the same operation over a selected period of time.

RTAS 300 will use a firmware routine to determine the nature of the fault and return fault isolation information to allow the failing hardware to be isolated. For the various recoverable error scenarios outlined above, the system components such as the PCI Host bridge, Terminal Bridge and PCI I/O adapter contain fault isolation registers that indicate the kinds of errors they detected. The firmware routine reads these registers and determines which components contain the fault and what fault information to return to the operating system. In presently available systems, each component in the system, such as, for example, a PCI host bridge, terminal bridge and PCI I/O adapter, contain fault isolation registers that indicate the kinds of errors they detect and the firmware routine, such as those which may be executed by a service processor, looks at the register values to determine the failing component.

In this manner, the mechanism of the present invention allows isolated recoverable error incidents to be handled without prematurely calling or identifying the particular hardware component as being bad or failed. Additionally, through setting different thresholds, the mechanism of the present invention allows hardware components to be identified as requiring repair or replacement.

Depending on the implementation, a different or modified device driver function may be used to test adapters. The diagnostics processes also may use a different threshold for failure. As a result, if during a diagnostics test a device driver detected a recoverable error, the device driver may make a call to permanently reset call to determine the failing components independently of the normal device driver threshold.

Operating system 302 includes diagnostic processes 312 to check for problems with I/O adapters. During diagnostic test of an I/O adapter the diagnostics may use different or modified device driver 306 to indicate a failure even on the first occurrence of a recoverable error. The same RTAS call used to mark the slot permanently unavailable would be used to get fault isolation information for the diagnostics case. After determining the fault information, the diagnostics may not wish to keep the device in a permanently unavailable state unless the threshold of unrecoverable errors was reached. Hence after the failure analysis, diagnostics could issue the RTAS call to reconfigure the slot for the adapter using the same function as if a replacement PCI device had been hot-plugged into the slot.

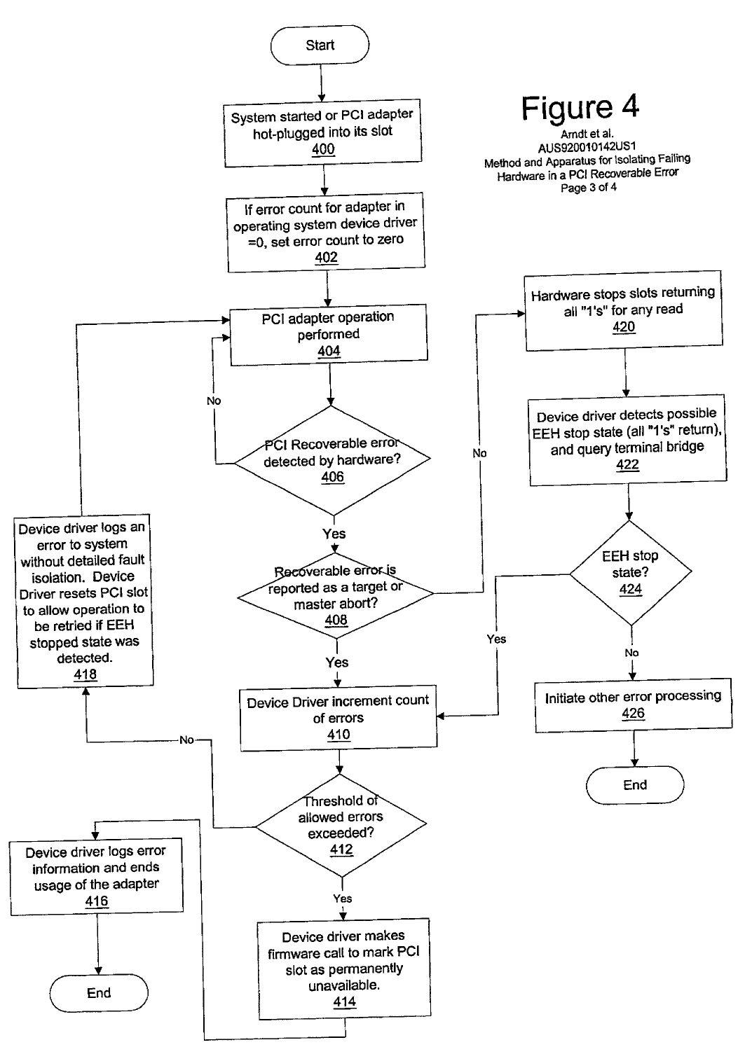

With reference now to FIG. 4, a flowchart of a process used for handling errors is depicted in accordance with a preferred embodiment of the present invention. The process illustrated in FIG. 4 may be implemented in a device drive, such as device drive 306 in FIG. 3.

The process begins when the data processing system starts or a component is hot-plugged into the PCI adapter slot (step 400). If the error count for adapter in the operating system device driver is not equal to zero, then the error count is set to zero (step 402). Next, the PCI adapter function is performed (step 404). This function may include performing various I/O operations, such as load, store, or direct memory access (DMA) operations.

A determination is then made as to whether the PCI recoverable error is detected by the hardware (step 406). If a recoverable error is detected, a determination is made as to whether the recoverable error is a master or target abort detected by the device driver as an interrupt (step 408). If the answer to this determination is yes, the device driver will increment the count of errors (step 410). When a recoverable error occurs, whether detected by a master or target abort or the EEH mechanism, a determination is made as to whether the allowed errors have exceeded a threshold (step 412). If the allowed errors have exceeded the threshold, the device driver makes a firmware call to mark the PCI slot as permanently unavailable (step 414). This call is made to an RTAS, such as RTAS 300 in FIG. 3. Further, the firmware determines the cause of the failure and returns the error isolation information to the device driver. In this example, the device driver logs the error information and ends usage of the adapter (step 416) with the process terminating thereafter.

With reference back to step 412, if the allowed errors have not exceed the threshold, the device driver logs an error to the system without a detailed fault isolation, resets the PCI slot, and removes the EEH stopped state terminal bridge for the slot in the EEH case to allow operation to be retried (step 418) with the process returning to step 404 as described above.

Turning again to step 408 if the recoverable error is not reported as a target or master abort, then the hardware stops slots from returning all “1's” for any read (step 420). The device driver detects possible EEH stop states (all “1's return) and queries the terminal bridge (step 422). A determination is then made as to whether an EEH stopped state is present (step 424). If an EEH stopped state is not present, other error processing is initiated (step 426) with the process terminating thereafter. Otherwise the process returns to step 410 as described above.

With reference again to step 406, if the PCI recoverable error is not detected by the hardware, the process returns to step 404 as described above.

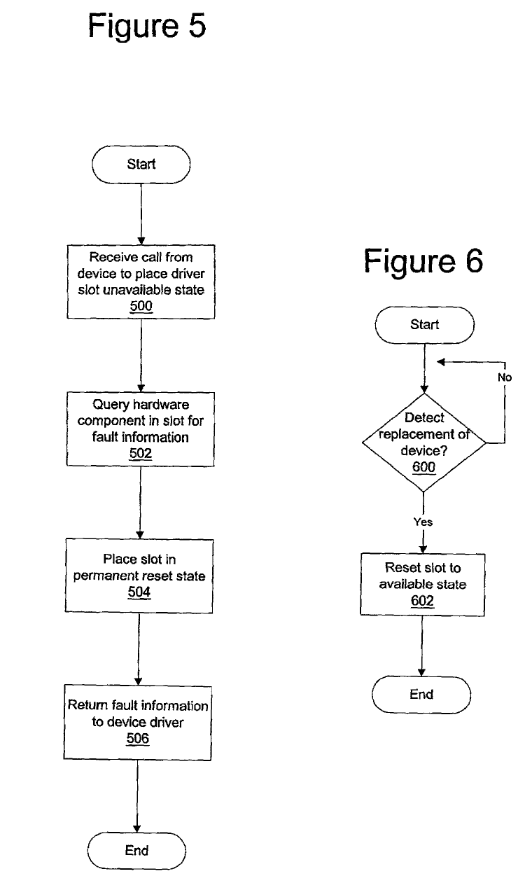

Turning now to FIG. 5, a flowchart of a process used for placing a device into an unavailable state is depicted in accordance with a preferred embodiment of the present invention. The process illustrated in FIG. 5 may be implemented in an RTAS, such as RTAS 300 in FIG. 3.

The process begins be receiving a call from a device driver to place the slot in an unavailable state (step 500). Thereafter, a query is made to the hardware component in the slot to obtain fault information (step 502). Next, the slot is placed in a permanent reset state (step 504). The fault information is then returned to the device driver (step 506) with the process terminating thereafter.

With reference now to FIG. 6, a flowchart of process used for resetting a slot is depicted in accordance with a preferred embodiment of the present invention. The process illustrated in FIG. 6 may be implemented within firmware, such as RTAS 300 in FIG. 3.

The process begins by determining whether the replacement of the device in a slot marked as permanently reset has been replaced (step 600). This replacement may occur while the data processing system is running by a hot-plug operation. Alternatively, this check may occur when the data processing system restarts or is turned on. In a hot-plug or hot swap operation, a component is pulled out from a system and a new component is plugged into the system while the power is still on and the system is still operating. If a replacement has not occurred, the process returns to step 600. Upon detecting replacement of the device, the slot in which the device is placed is set to an available state (step 602) with the process terminating thereafter.

Thus, the mechanism of the present invention provides a method, apparatus, and computer implemented instructions for handling errors and isolating failing hardware in response to recoverable errors. The mechanism of the present invention, in these examples, causes a device driver to use a kernel service to issue a call to firmware to permanently reset a slot containing a device after a threshold of failures has occurred. In the depicted examples, this threshold is when more than three consecutive attempts for the same operation, such as transferring the same data has occurred. The firmware holds the slot in a permanent reset state in case the device driver attempts to access the particular device at a later time. Such an attempted access would result in the device driving receiving an indication that the device is unavailable.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMS, DVD-ROMS, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for isolating failing hardware in the data processing system, the method comprising:
responsive to detecting a recovery attempt from an error for an operation involving a hardware component, storing an indication of the attempt; and
responsive to the error exceeding a threshold, placing the hardware component in an unavailable state.

2. The method of claim 1 further comprising:
clearing the unavailable state of the hardware component in response to a hot-plug action replacing the hardware component.

3. The method of claim 1, wherein the placing step comprises:
making a call to a hardware interface layer to place the hardware component into a permanent reset state.

4. The method of claim 1, wherein the indication is stored in an error log.

5. The method of claim 1 further comprising:
responsive to a selected number of recovery attempts occurring, recreating the error.

6. The method of claim 1, wherein the error is an error caused by a PCI bus operation.

7. The method of claim 1, wherein the detecting and placing steps occur in a firmware layer within the data processing system.

8. The method of claim 1, wherein the detecting step occurs in a device driver and placing steps occurs in a firmware.

9. The method of claim 1, wherein the threshold is the error successively a selected number of times.

10. A method in a data processing system for handling errors, the method comprising:
responsive to an occurrence of an error, determining whether the error is a recoverable error;
responsive to a determination that the error is a recoverable error, identifying slots on the bus indicating an error state;
incrementing an error counter for each identified slot; and
responsive to the error counter exceeding a threshold, placing the slot into a permanently unavailable state.

11. The method of claim 10 further comprising:
responsive to the error counter failing to exceed the threshold, placing the slot into an available state, wherein a device within the slot resumes functioning.

12. A data processing system comprising:
a bus system;
a communications unit connected to the bus system;
a memory connected to the bus system, wherein the memory includes as set of instructions; and
a processing unit connected to the bus system, wherein the processing unit executes the set of instructions to store an indication of a recovery attempt from an error in response to detecting the recovery attempt; and place the hardware component in an unavailable state in response to the error exceeding a threshold.

13. A data processing system comprising:
a bus system;
a communications unit connected to the bus system;
a memory connected to the bus system, wherein the memory includes as set of instructions; and
a processing unit connected to the bus system, wherein the processing unit executes the set of instructions to determine whether the error is a recoverable error in response to an occurrence of an error; identify slots on the bus indicating an error state in response to a determination that the error is a recoverable error; increment an error counter for each identified slot; and place the slot into a permanently unavailable state in response to the error counter exceeding a threshold.

14. A data processing system for isolating failing hardware in the data processing system, the data processing system comprising:
storing means, responsive to detecting a recovery attempt from an error, for storing an indication of the attempt; and
placing means, responsive to the error occurring in the more than a threshold for a hardware component, for placing the hardware component in an unavailable state.

15. The data processing system of claim 14 further comprising:
clearing means for clearing the unavailable state of the hardware component in response to a hot-plug action replacing the hardware component.

16. The data processing system of claim 14, wherein the placing means comprises:
means for making a call to a hardware interface layer to place the hard ware component into a permanent reset state.

17. The data processing system of claim 14, wherein the indication is stored in an error log.

18. The data processing system of claim 14 further comprising:
recreating means, responsive to a selected number of recovery attempts occurring, for recreating the error.

19. The data processing system of claim 14, wherein the error is an error caused by a PCI bus operation.

20. The data processing system of claim 14, wherein the detecting means and the placing means are located in a firmware layer within the data processing system.

21. The data processing system of claim 14, wherein the detecting means is located in a device driver and the placing means is located in a firmware.

22. The data processing system of claim 14, wherein the threshold is the error successively a selected number of times.

23. A data processing system for handling errors, the data processing system comprising:
determining means, responsive to an occurrence of an error, for determining whether the error is a recoverable error;
identifying means, responsive to a determination that the error is a recoverable error, for identifying slots on the bus indicating an error state;
incrementing means for incrementing an error counter for each identified slot; and
placing means, responsive to the error counter exceeding a threshold, for placing the slot into a permanently unavailable state.

24. The data processing system of claim 23, wherein the placing means is a first placing means and further comprising:
second placing means, responsive to the error counter failing to exceed the threshold, for placing the slot into an available state, wherein a device within the slot resumes functioning.

25. A computer program product in a computer readable medium for isolating failing hardware in the data processing system, the computer program product comprising:
first instructions, responsive to detecting a recovery attempt from an error, for storing an indication of the attempt; and
second instructions, responsive to the error occurring in the more than a threshold for a hardware component, for placing the hardware component in an unavailable state.

26. The computer program product of claim 25 further comprising:
third instructions for clearing the unavailable state of the hardware component in response to a hot-plug action replacing the hardware component.

27. The computer program product of claim 25, wherein the placing step comprises:
third instructions for making a call to a hardware interface layer to place the hard ware component into a permanent reset state.

28. The computer program product of claim 25, wherein the indication is stored in an error log.

29. The computer program product of claim 25 further comprising:
third instructions, responsive to a selected number of recovery attempts occurring, for recreating the error.

30. The computer program product of claim 25, wherein the error is an error caused by a PCI bus operation.

31. The computer program product of claim 25, wherein the detecting and placing steps occur in a firmware layer within the data processing system.

32. The computer program product of claim 25, wherein the detecting step occurs in a device driver and placing steps occurs in a firmware.

33. The computer program product of claim 25, wherein the threshold is the error successively a selected number of times.

34. A computer program product in a computer readable medium for handling errors, the computer program product comprising:
first instructions, responsive to an occurrence of an error, for determining whether the error is a recoverable error;
second instructions, responsive to a determination that the error is a recoverable error, for identifying slots on the bus indicating an error state;
third instructions for incrementing an error counter for each identified slot; and
fourth instructions, responsive to the error counter exceeding a threshold, for placing the slot into a permanently unavailable state.

35. The computer program product of claim 34 further comprising:
fifth instructions, responsive to the error counter failing to exceed the threshold, for placing the slot into an available state, wherein a device within the slot resumes functioning.
